(19) United States
(12) Patent Application Publication
(10) Pub. No.: US 2022/0002592 A1
(43) Pub. Date: Jan. 6, 2022

(54) SILICONE ADHESIVE

(71) Applicant: Tonsan Adhesives, Inc., Beijing (JP)

(72) Inventors: Dan Su, Beijing (CN); YongQuan Chen, Beijing (CN); Yao Wang, Beijing (CN); Ming Xiao, Beijing (CN)

(21) Appl. No.: 17/289,411

(22) PCT Filed: Oct. 31, 2018
(86) PCT No.: PCT/IB2019/001223

§ 371 Date: Apr. 28, 2021

(51) Int. Cl. C09J 7/30; C09J 11/08; C09J 7/10; C09J 11/04

(52) U.S. Cl. CPC C09J 7/30; C09J 11/08; C09J 2417/00; C09J 11/04; C09J 2483/00; C09J 7/10

(57) ABSTRACT

A silicone adhesive comprises a polysiloxane with a hydroxyl group and/or a hydrolyzable group bonded with a silicon atom, a catalyst, a cross-linking agent, and a filler, wherein the filler comprises at least one rubber filler. The silicone adhesive not only reduces costs, but also maintains the original performance of the adhesive, reduces the hardness, and improves the moisture and heat aging resistance of the adhesive.

### TECHNICAL FIELD

The present invention relates to the field of silicone polymers, in particular to a silicone adhesive.

### BACKGROUND

Room-temperature vulcanized silicone adhesives have been widely used in construction, electronics, industry, automobiles, and new energy fields due to their excellent operability, heat resistance, and weather resistance. It is often required to add various fillers to the silicone adhesives to meet specific use requirements, such as tensile strength as well as moisture and heat aging resistance. In addition, since silicone adhesives are a developed technology in a competitive market, the market requirements for the costs of silicone adhesives are extremely high. To reduce the costs of silicone adhesives, the most commonly used methods include increasing the amount of fillers used or adding other low-cost solvent oils such as mineral oil. However, when the addition amounts of fillers such as calcium carbonate, aluminum oxide, silica powder, kaolin, white fused alumina, and the like are excessively high, although costs will be greatly reduced, such fillers will bring an increase in hardness and a decrease in elongation, increase the risk of colloid cracking, and gradually fail to meet market requirements. Moreover, these solvent oils such as mineral oil have poor compatibility with silicone systems, and tend to precipitate during application, resulting in pollution, cracking, degraded moisture and heat aging performance, and other adverse effects. These problems are undesired in the application of silicone adhesives. Therefore, the present problems include how to maintain the basic properties of silicone adhesives while maintaining low costs of the silicone adhesives, and how to improve the hardness and moisture and heat aging resistance thereof.

### SUMMARY

In view of the problems in the prior art found by the inventor, the inventor of the present application has carried out extensive research in the field of silicone adhesives in order to obtain a silicone adhesive with low costs, low hardness, and excellent moisture and heat aging resistance.

Since the main polymer of rubber is hydrocarbons, which are different from the siloxane structure of silicone and belong to a completely different system and technical field, it is usually unlikely that people should conceive of combining hydrocarbon-based rubber with siloxane-based silicone. The inventor found that adding rubber such as waste rubber as a filler into silicone adhesives did not significantly increase the hardness of colloids as compared with silicone adhesives using conventional fillers, but greatly improved the retention rate thereof of double-85 moisture and heat aging resistance for 1,000 hours, which exceeded 70%, and increased the elongation at break thereof, thereby solving the current technical problems.

One purpose of the present invention is to provide a silicone adhesive. Another purpose of the present invention is to provide a method for recycling waste rubber.

The present invention provides a silicone adhesive, comprising a polysiloxane with a hydroxyl group and/or a hydrolyzable group bonded with a silicon atom, a catalyst, a cross-linking agent and a filler, wherein the filler comprises at least one rubber filler.

The present disclosure has the following features:
1. Compared with inorganic fillers and cheap solvent oils, the addition of rubber particles will not bring an increase in the hardness and the cracking of the adhesive and can improve the flexibility of the silicone adhesive.
2. The addition of the rubber powder improves the water resistance and moisture and heat aging resistance of the silicone adhesive.
3. The present disclosure provides a new approach to recycle a rubber powder, which is conducive to environmental management and protection.
4. The present disclosure utilizes for the first time a rubber filler in the silicone field and combines different technologies in different technical fields, achieving a new technological breakthrough in the silicone field.

### DETAILED DESCRIPTION

In one aspect of the present invention, the present invention provides a silicone adhesive, including a polysiloxane with a hydroxyl group and/or a hydrolyzable group bonded with a silicon atom, a catalyst, a cross-linking agent and a filler, wherein the filler comprises at least one rubber filler.

In the present invention, the polysiloxane is a matrix polymer of the silicone adhesive. The polymer is a polysiloxane with a hydroxyl group and/or a hydrolyzable group on a molecular chain, and the hydroxyl group and the hydrolyzable group are bonded with a silicon atom. Herein the hydrolyzable group refers to a group that can be hydrolyzed, and a hydroxyl produced by hydrolysis is bonded with a silicon atom. The molecular structure of the polysiloxane is not specifically limited and may be a linear chain, may be branched, or may be dendritic without a main chain. Preferably, the polysiloxane used in the present invention is a linear-chain or branched polysiloxane whose main chain substantially consists of organic siloxane repeating units; in this case the hydroxyl group and the hydrolyzable group is located at the end of the molecular chain. In addition, the polysiloxane may also comprise one or a plurality substituent groups selected from the group consisting of a halogen and a fluorine group bonded with a silicon atom.

In the present invention, the polysiloxane comprises a hydroxyl group or a hydrolyzable group bonded with a silicon atom. The hydrolyzable group is preferably an alkoxy group and/or an alkoxy-substituted alkoxy group. The alkoxy used as the hydrolyzable group in the polysiloxane is preferably an alkoxy group with one to 10 carbon atoms, particularly preferably one to 4 carbon atoms, such as a methoxy group, an ethoxy group, a propoxy group, an isopropoxy group, a butoxy group, a hexyloxy group, and an octyloxy group. The alkoxy-substituted alkoxy group used as the hydrolyzable group in the polysiloxane is preferably an alkoxy-substituted alkoxy group with a total of two to 10 carbon atoms, particularly preferably three or four carbon atoms, such as a methoxymethoxy group, a methoxyethoxy group, an ethoxymethoxy group, and an ethoxyethoxy group.

In one preferred embodiment of the present invention, the polysiloxane may include only the hydroxy group or include only the hydrolyzable group.

The number of hydroxyl groups and/or hydrolyzable groups in the polysiloxane is not particularly limited, and preferably the total number of hydroxyl groups and/or hydrolyzable groups in each molecule of the polysiloxane is greater than or equal to two. In one preferred embodiment of the present invention, the polysiloxane is a polysiloxane with a hydroxyl group and/or a hydrolyzable group at the end of the chain.

As the polysiloxane usable for the silicone adhesive in the present invention, preferably a polysiloxane with a viscosity of 100 to 100,000 mPa.s at 25° C. is used, and preferably a polysiloxane with a viscosity of 1,000 to 50,000 mPa.s at 25° C. is used.

The polysiloxane usable for the silicone adhesive in the present invention may be a hydroxyl-terminated polydimethylsiloxane, a methoxy-terminated polysiloxane, or a hydroxyl MQ resin.

A feature of the silicone adhesive provided by the present invention is the inclusion of a rubber filler. The rubber filler type is not particularly limited, and may be natural rubber, nitrile-butadiene rubber, cis-butadiene rubber, styrene-butadiene rubber, isoprene rubber, chloroprene rubber, ethylene propylene rubber, or any combination thereof. Preferably, a waste rubber powder, such as a waste ethylene propylene rubber powder, is used. Favorably, the infrared spectrum of the rubber filler has an absorption peak from 2,800 to 3,000.

The source of the rubber filler used for the silicone adhesive provided by the present invention is not particularly limited. The rubber filler may originate from rubber raw materials and powders made from new rubber products and/or waste rubber products. With consideration to costs and environmental protection, preferably a waste rubber powder is used. For example, the rubber powder may originate from powders made from waste tires, waste rubber shoes, waste rubber hoses, leftovers and wastes produced thereof in a production process of rubber products, such as a waste styrene-butadiene rubber tire powder, a waste chloroprene rubber hose powder, and a waste ethylene propylene rubber hose powder.

In one embodiment of the present invention, the average particle size of the rubber filler is less than or equal to 50 mesh, preferably less than or equal to 70 mesh, more preferably less than or equal to 80 mesh, and particularly preferably less than or equal to 100 mesh. In another embodiment of the present invention, the average particle size of the rubber filler is greater than or equal to 600 mesh, preferably greater than or equal to 500 mesh, more preferably greater than or equal to 400 mesh, and particularly preferably greater than or equal to 300 mesh. In one particularly preferred embodiment of the present invention, the average particle size of the rubber filler is 50 to 500 mesh, preferably 80 to 400 mesh. If the average particle size is excessively small, the viscosity of the silicone adhesive increases, the extrudability becomes poor, and is the rubber filler will be difficult to operate; if the particle size is excessively large, the storage stability will be affected, and the filler will easily precipitate.

The silicone adhesive provided by the present invention may further include other fillers in addition to the rubber filler. For example, the silicone adhesive may further include one or a plurality of calcium carbonate, talc powder, zinc borate, a phosphate, titanium dioxide, silica powder, quartz powder, aluminum hydroxide, aluminum oxide, white carbon black, magnesium oxide, zinc oxide, barium carbonate, diatomite, kaolin, and montmorillonite. In one embodiment of the present invention, based on 100 parts of the polysiloxane by mass, the silicone adhesive includes 10 to 300 parts, preferably 100 to 200 parts of the filler by mass. In another preferred embodiment of the present invention, the mass proportion of the rubber filler in the filler is from 10% to 70% and preferably from 20% to 60%.

In order to increase the adhesion between the silicone adhesive and the substrate and increase the compatibility between the components, the silicone adhesive may further include a coupling agent. Favorably, the coupling agent is one or a plurality selected from the group consisting of a silane coupling agent and a titanate coupling agent. The silane coupling agent is preferably one or a plurality of an aminosilane coupling agent, an epoxysilane coupling agent, an acyloxysilane coupling agent, a vinylsilane coupling agent, a titanate silane coupling agent, a mercaptosilane coupling agent, and an isocyanate silane coupling agent. Further preferably, the silane coupling agent is one or a plurality selected from the group consisting of γ-aminopropyltrimethoxysilane, γ-aminopropyltriethoxysilane, γ-(methacryloxy)propyltrimethoxysilane, γ-aminopropylmetyldimethoxysilane, γ-aminopropylmethyldiethoxysilane, aniline methyltriethoxysilane, N-(β-aminoethyl)-γ-aminopropyltrimethoxysilane, N-(β-aminoethyl)-γ-aminopropyltriethoxysilane, N-(β-aminoethyl)-γ-aminopropylmethyldimethoxysilane, γ-mercaptopropyltrimethoxysilane, γ-mercaptopropyltriethoxysilane, γ-(2,3)-epoxypropoxy)propyltriethoxysilane, 3-[(2,3)-epoxypropoxy]propylmethyldimethoxysilane, propyltriethoxysilane isocyanate, γ-ureidopropyltrimethoxysilane, γ-glycidoxypropyltrimethoxysilane, and a silane coupling agent containing an alkyl group with 12 or more carbon atoms. The silane coupling agent containing an alkyl group with 12 or more carbon atoms is usually solid at room temperature, and thus can be referred to as a dry silane.

In one preferred embodiment of the present invention, the silane coupling agent containing an alkyl group with 12 or more carbon atoms has the following structure:

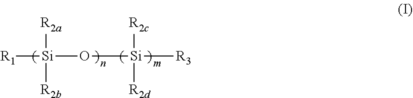

wherein

R₁ is a vinyl group, a methoxy group or a y-(methacryloxy)propyl group;

R₂ₐ and R_{2b} are identical to or different from each other, and are independently an alkyl or alkoxy group with atoms greater than or equal to 12 and less than or equal to 25, preferably greater than or equal to 18 and less than or equal to 20, and more preferably an alkoxy group with atoms greater than or equal to 18 and less than or equal to 20;

R_{2c} and R_{2d} are identical to or different from each other, and are independently an alkyl or alkoxy group with atoms greater than or equal to 12 and less than or equal to 25, preferably greater than or equal to 18 and less than or equal to 20, and more preferably an alkoxy group with atoms greater than or equal to 18 and less than or equal to 20;

n is any integer from zero to 12, such as zero, one, two, three or four;

m is zero or one, but m and n are not zero at the same time; and

when m is zero, R₃ is a C₁-C₂₀ alkyl group, preferably a methyl group, an ethyl group, a propyl group or a C₁₈ a alkyl group; and when m is one, R₃ is a vinyl group, a methoxy group, an ethoxy group, a propoxy group, a γ-(methacryloxy)propyl group or an alkoxy group with carbon atoms greater than or equal to 12 and less than or equal to 25, preferably greater than or equal to 18 and less than or equal to 20. For example, the silane coupling agent containing an alkyl group with 12 or more carbon atoms is one or a plurality selected from the group consisting of (CH₂CH)(C₁₈H₃₆O)₂SiOSi(C₁₈H₃₆O)₂(CH₂CH), (CH₃O)(C₁₈H₃₆O)₂SiOSi(C₁₈H₃₆O)₂(CH₃O), (CH₂CH)Si(C₁₈H₃₆O)₃ and (CH₂CH)(C₁₈H₃₆O)₂SiOCH₂CH₂CH₃.

Preferably, the silicone adhesive provided by the present invention includes at least one of a silane coupling agent containing an alkyl group with 12 or more carbon atoms and/or a titanate coupling agent containing a carbon chain with 12 or more carbon atoms. The use of the silane coupling agent containing an alkyl group with 12 or more carbon atoms and/or the titanate coupling agent containing a carbon chain with 12 or more carbon atoms will not add additional processes and increase energy consumption, but will save energy and further enable the rubber powder to be evenly dispersed in the silicone rubber system, so that no defect points will be formed after curing, thereby facilitating the increase of body strength.

In the present invention, the titanate coupling agent may be isopropyl titanate triisostearate or a compound coupling agent comprising isopropyl titanate triisostearate, isopropyl titanate isostearate, or a compound coupling agent comprising isopropyl titanate isostearate, such as UP-133 (Nanjing Upchemical Co., Ltd.), or UP-132 (Nanjing Upchemical Co., Ltd.).

In one preferred embodiment of the present invention, based on 100 parts of the polysiloxane by mass, the silicone adhesive comprises 0.1 to 20 parts, preferably one to 10 parts of the coupling agent by mass. In another embodiment of the present invention, based on 100 parts of the polysiloxane, the amount of the silane coupling agent containing an alkyl group with 12 or more carbon atoms and/or the titanate coupling agent containing a carbon chain with 12 or more carbon atoms is 0.1 to 10 parts by mass, preferably 0.5 to five parts by mass.

The silicone adhesive provided by the present invention further includes a cross-linking agent. The cross-linking agent reacts with the polysiloxane to form a network structure, thus achieving curing of the silicone adhesive. The cross-linking agent usable in the present invention is any cross-linking agent suitable for the silicone adhesive. In the present invention, in general the cross-linking agent may be a hydrolyzable organic siloxane compound having more than three hydrolyzable groups boned with a silicon atom in a molecule, and/or a partial hydrolyzate thereof. As the hydrolyzable group of the hydrolyzable organic silane compound of the cross-linking agent, the following groups with a total of one to 10 carbon atoms can be listed: an alkoxy group, an alkoxy-substituted alkoxy group, an acyloxy group, an alkenoxy group, an aryl group, an aminoxy group, and an acylamino group. For example, the hydrolyzable group may be an alkoxy group such as a methoxy group, an ethoxy group and a propoxy group; an alkoxy-substituted alkoxy group such as a methoxyethoxy group, an ethoxyethoxy group, and a methoxypropoxy group; an acyloxy group such as an acetoxy group, and an octanoyloxy group; an alkenoxy group such as a vinyloxy group and an isopropenyloxy group; a ketone oxime group such as a dimethyl ketone oxime group, a methyl ethyl ketone oxime group, and a methyl isobutyl ketone oxime group; an aminoxy group such as a dimethyl aminoxy group and a diethyl aminoxy group; and an acylamino group such as a 2-methyl acetamido group and a 2-ethyl acetamido group.

In addition to the hydrolyzable groups mentioned above, the cross-linking agent may further include an organic group bonded with a silicon atom. The organic group may be a monovalent hydrocarbyl group with one to 18 carbon atoms, preferably one to 11 carbon atoms. For example, the organic group may be an alkyl group such as a methyl group, an ethyl group, a propyl group, a nonyl group, and an octadecyl group; a cycloalkyl group such as a cyclopentyl group and a cyclohexyl group; an alkenyl group such as a vinyl group, an allyl group, and a propenyl group; an aryl group such as a phenyl group, a methylphenyl group, a dimethylphenyl group and a naphthyl group; and an aralkyl group such as a benzyl group, a phenylethyl group, and a phenylpropyl group. The above hydrocarbyl group may be unsubstituted or substituted by groups selected from the group consisting of halogen atoms F, Cl and Br and a cyano group, and is, for example, a halogenated alkyl group of 3-chloropropyl, 3,3-trifluoropropyl, etc. Preferably, the monovalent hydrocarbyl mentioned above is a methyl group, an ethyl group, a propyl group, a vinyl group and a phenyl group.

As the cross-linking agent, the following can be listed: an alkoxysilane such as methyltrimethoxysilane, ethyltrimethoxysilane, decyltrimethoxysilane, vinyltrimethoxysilane, phenyltrimethoxysilane, methyltriethoxysilane, ethyltriethoxysilane, vinyltriethoxysilane, phenyltriethoxysilane, tetramethoxysilane and tetraethoxysilane; an arylsilane such as methyltri(propanoneoxime)silane, methyltri(butanoneoxime)silane, phenyltri(butanoneoxime)silane, vinyltri(butanoneoxime)silane and tetra(butanoneoxime)silane; an alkoxy-substituted alkoxy group silane such as methyltri(methoxymethoxy)silane, ethyltri(methoxymethoxy)silane, vinyltri(methoxymethoxy)silane, phenyltri(methoxymethoxy)silane, methyltri(ethoxymethoxy)silane and tetra(methoxymethoxy)silane; an aminoxy silane such as methyltri(N,N-diethylaminooxy)silane; an acylamino silane such as methyltri(N-methylacetamide)silane, methyltri(N-butylacetamide)silane and methyltri(N-cyclohexylacetamide)silane; and an acetoxy silane such as methyltriisopropyloxysilane, vinyltriisopropyloxysilane, phenyltriisopropyloxysilane, vinyltriacetoxysilane, methyltriacetoxysilane and phenyltriacetoxysilane.

The cross-linking agent may be used alone or a plurality than two cross-linking agents may be used in combination. In addition, a silane compound and/or siloxane with two hydrolyzable groups in one molecule may also be used without hindering the effect in the scope of the present invention.

In one preferred embodiment of the present invention, based on 100 parts of the polysiloxane by mass, the silicone adhesive comprises one to 30 parts, and preferably five to 20 parts of the cross-linking agent by mass.

Note that the silane compound and/or siloxane that can be used as the cross-linking agent in the present invention are different from the polysiloxane: the polysiloxane is a polymer and has a repeating structural unit, while the silane compound and/or siloxane used as the cross-linking agent is a small molecular compound.

The silicone adhesive provided by the present invention further includes a catalyst. The catalyst is used to catalyze the reaction between polysiloxane and the cross-linking agent, thus curing the silicone adhesive system. In the present invention, generally speaking, the catalyst is one or a plurality selected from the group consisting of organic tin, organic titanium and organic bismuth catalysts. Preferably, the catalyst is one or a plurality of dibutyltin diacetate, dioctyltin diacetate, dibutyltin dilaurate, dioctyltin dilaurate, dibutyltin diisooctylmaleate, dibutyltin dioctate, tetrabutyl titanate, tetra-tert-butyl titanate, tetraisobutyl titanate, tetraisopropyl titanate, diisopropyl bis(ethylacetoacetato) titanate, diisopropyl bis(acetylacetonyl) titanate, bismuth isooctanate, bismuth laurate, bismuth neodecanoate and bismuth naphthenate.

In one embodiment of the present invention, based on 100 parts of the polysiloxane by mass, the silicone adhesive comprises 0.01 to one part, and preferably 0.1 to 0.6 parts of the catalyst by mass.

In order to increase the processability of the silicone adhesive, the silicone adhesive may further include a plasticizer. Preferably, the plasticizer (25° C.) is dimethyl silicone oil with a viscosity of 10 to 2,000 mPa.s. In one preferred embodiment of the present invention, based on 100 parts of the polysiloxane by mass, the silicone adhesive includes one to 100 parts, preferably five to 60 parts of the plasticizer by mass.

The silicone adhesive provided by the present invention may further includes a dehydrating agent, a pigment, and etc.

The adhesive provided by the present invention may be two-component or single-component, preferably single-component. When the adhesive is two-component, the polysiloxane can be placed separately from the catalyst, and the other components may be selectively added to the polysiloxane or catalyst component according to needs.

In the present invention, the used raw materials may be commercially acquired. Unless otherwise specified, the amounts of the used raw materials are in parts by mass. The numerical range refers to any value in an available interval. For example, for one to 30 parts, it may be 10, 10.9, 20, and etc.

The present invention will be further described below using embodiments, but the present invention is not limited thereto.

### Embodiments

Embodiments 1 to 17 and Comparative Examples 1 to 3

The raw materials and amount involved in the embodiments and comparative examples are as follows:

Polysiloxane:

A1 20000 mPa.s hydroxyl-terminated polydimethylsiloxane (Wynca Group)

A2 80000 mPa.s hydroxyl-terminated polydimethylsiloxane (Wynca Group)

A3 50000 mPa.s vinyl dimethoxysilane-terminated a,w-dihydroxy polydimethylsiloxane (prepared according to Example 1 in the description of Chinese Patent Application No. 201410155699.9)

A4 1000 mPa.s hydroxyl-terminated polydimethylsiloxane (Dow Silicones (Zhangjiagang) Co., Ltd.)

A5 Hydroxy MQ resin YDSR1002 (Shanghai Yound New Material Technology Co., Ltd.) Filler

B1 Calcium carbonate (Guangxi Huana New Material Technology Co., Ltd., 008-18)

B2 Calcium carbonate (Zhejiang Tianshi Nano-Tech Co., Ltd., TN-M3)

B3 Silica powder (Guangdong Yufeng Powder Material Co., Ltd.)

B4 Aluminum hydroxide (Foshan Victor Chemical Material Co., Ltd., FA-50K)

B5 Aluminum oxide (Foshan Victor Chemical Material Co., Ltd., AR-30)

B6 80-mesh recycled waste tire rubber powder (natural rubber as the main component)

B7 600-mesh tire rubber powder (styrene-butadiene rubber)

B8 200-mesh waste rubber hose powder (ethylene propylene rubber)

B9 200-mesh waste sole rubber powder (styrene-butadiene rubber)

B10 400-mesh nitrile-butadiene rubber Nipol 1411 (Zone, Japan)

Silane Coupling Agent:

C1 (CH₂CH)(C₁₈H₃₆O)₂SiOSi(C₁₈H₃₆O)₂(CH₂CH) (Hubei Limeida Silicon Fluorine Technology Co. Ltd., A1003)

C2 (CH₃O)(C₁₈H₃₆O)₂SiOSi(C₁₈H₃₆O)₂(CH₃O)

C3 UP-133 (Nanjing Upchemical Co., Ltd.)

C4 γ-aminopropyltrimethoxysilane (Nanjing Union Silicon Chemical Co., Ltd., USi-1302)

C5 γ-glycidoxypropyltrimethoxysilane (Nanjing Union Silicon Chemical Co., Ltd., USi-2301)

Cross-Linking Agent:

D 1 Vinyltri(butanoneoxime)silane (Hubei Bluesky New Material, Inc., D91)

D2 Methyltrimethoxysilane catalyst (Hubei Bluesky New Material, Inc., D30) Catalyst

E1 Dibutyltin dilaurate (Nitto Kasei Co., Ltd., U-12)

E2 Tetrabutyl titanate (Aladdin Reagent (Shanghai) Co., Ltd.)

Plasticizer:

F1 500 mpa.s dimethyl silicone oil (Jiangxi Bluestar Xinghuo Silicone Co., Ltd., 201 silicone oil-500cp).

### Embodiment 1

One hundred parts of polysiloxane A1, 10 parts of plasticizer F1, 80 parts of filler B1, 50 parts of filler B6 and two parts of silane coupling agent C1 were added to a kneader. The kneader was powered on for stirring and dispersion. Dehydration was performed for three hours at a temperature of 130° C. to 140° C. in a vacuum condition of −0.09 MPa to −0.1 MPa, and then the temperature was decreased to less than 40° C. to obtain a slurry. The slurry was transferred to a planetary mixer. Ten parts of cross-linking agent D1, one part of silane coupling agent C4, one part of silane coupling agent C5 and 0.3 parts of catalyst E1 were added to the slurry under the protection of N2, and the slurry was stirred evenly under a vacuum condition of −0.09 Mpa to −0.1 MPa until no bubbles were formed, to obtain a silicone adhesive.

### Embodiments 2 to 17 and Comparative Examples 1 to 3

By adopting the similar operations described in Embodiment 1, silicone adhesives were prepared according to the formulas as shown in Table 1 below. For the addition of the silane coupling agent, silane coupling agents C2 and C3 were added at the same time as the time at which silane coupling agent C1 was added

TABLE 1

| | | | | | | | | | | | | | | | | | | Comparative | | |
|---|---|---|---|---|---|---|---|---|---|---|---|---|---|---|---|---|---|---|---|---|
| | Embodiment | | | | | | | | | | | | | | | | | Example | | |
| S/N | 1 | 2 | 3 | 4 | 5 | 6 | 7 | 8 | 9 | 10 | 11 | 12 | 13 | 14 | 15 | 16 | 17 | 1 | 2 | 3 |
| A1 | 100 | 100 | 100 | 100 | 100 | 100 | 100 | 100 | 100 | 100 | 100 | 100 | | 100 | 100 | | 100 | 100 | 100 | 100 |
| A2 | | | | | | | | | | | | | 50 | | | | | | | |
| A3 | | | | | | | | | | | | | | | | 70 | | | | |
| A4 | | | | | | | | | | | | | 50 | | | 15 | | | | |
| A5 | | | | | | | | | | | | | | | | 15 | | | | |
| B1 | 80 | 180 | 180 | 4 | 100 | 80 | 80 | 50 | 80 | 160 | 90 | | 80 | 80 | 80 | 50 | 100 | 80 | 80 | 200 |
| B2 | | | | | | | | | | | | | | | | | | 50 | | |
| B3 | | | | | | | | | | | | | | | | | | | 50 | |
| B4 | | | | | | | | | | | | 40 | | | | | | | | |
| B5 | | | | | | | | | | | | 40 | | | | | | | | |
| B6 | 50 | 50 | 20 | 9 | 200 | | | | | 40 | 60 | 120 | 50 | 50 | 50 | 50 | 50 | | | |
| B7 | | | | | | 50 | | | | | | | | | | | | | | |
| B8 | | | | | | | 50 | | | | | | | | | | 50 | | | |
| B9 | | | | | | | | 50 | | | | | | | | | | | | |
| B10 | | | | | | | | | 50 | | | | | | | | | | | |
| C1 | 2 | 1.5 | 2 | 2 | 4 | 2 | 7 | 2 | 0.5 | | | 2 | 2 | 2 | | 3 | | 2 | 2 | |
| C2 | | | | | | | | | | 2 | | | | | | | | | | |
| C3 | | | | | | | | | | | 2 | | | | | | | | | |
| C4 | 1 | 4 | 1 | 1 | 3 | 1 | 6 | 1 | 0.5 | 1 | 1 | 1 | 1 | 1 | 2 | | | 1 | 1 | |
| C5 | 1 | 2 | 1 | 1 | 3 | 1 | 7 | 1 | | 1 | 1 | 1 | 1 | 1 | 2 | 2 | | 1 | 1 | |
| D1 | 10 | 10 | 15 | 10 | 20 | 10 | 10 | 10 | 10 | 10 | 10 | 10 | 10 | | 10 | 5 | 12 | 10 | 10 | 12 |
| D2 | | | | | | | | | | | | | | 1 | | | | | | |
| E1 | 0.3 | 0.3 | 0.3 | 0.3 | 0.5 | 0.3 | 0.3 | 0.3 | 0.3 | 0.3 | 0.3 | 0.3 | 0.3 | | 0.3 | 0.05 | | 0.3 | 0.3 | |
| E2 | | | | | | | | | | | | | | 0.3 | | | 0.6 | | | 0.6 |
| F1 | 10 | 10 | 10 | 10 | 50 | 10 | 10 | 10 | 10 | 10 | 10 | 10 | 10 | 10 | 10 | 20 | | 10 | 10 | |

The silicone adhesives prepared in the embodiments and comparative examples were prepared into adhesive films in accordance with GBIT 528-2009 Standard type-2 sample requirements. The adhesive films were cured for seven days at a constant temperature of 23±2° C. and a constant humidity of 50±5%. Tensile tests were performed at 25° C. using a universal tension machine (INSTRON) at a drawing rate of 500 mm/min to obtain the strength and elongation at break of the silicone elastomers. Double-85 refers to an environment with a temperature of 85° C. and a humidity of 85%. Shore A hardness was tested in accordance with GB/T 531.1-2008.

The data measured is listed in Table 2 below.

TABLE 2

| | | Tensile | | Tensile strength after | Retention rate of tensile |
|---|---|---|---|---|---|
| | Shore A | strength | Elongation | double-85 aging for | strength after double- |
| Sample | hardness | MPa | at break, % | 1000 h, MPa | 85 aging for 1000 h |
| Embodiment 1 | 40 | 2 | 300 | 1.7 | 85% |
| Embodiment 2 | 54 | 1.8 | 270 | 1.3 | 72.7% |
| Embodiment 3 | 50 | 2.1 | 280 | 1.65 | 78.5% |
| Embodiment 4 | 36 | 1.3 | 110 | 0.9 | 69.2% |
| Embodiment 5 | 40 | 1.9 | 280 | 1.55 | 81.5% |
| Embodiment 6 | 42 | 1.9 | 290 | 1.5 | 78.9% |
| Embodiment 7 | 41 | 2.1 | 310 | 1.7 | 80.9% |
| Embodiment 8 | 40 | 2.0 | 290 | 1.7 | 85% |
| Embodiment 9 | 39 | 1.9 | 310 | 1.6 | 84.2% |
| Embodiment 10 | 44 | 2.1 | 290 | 1.7 | 80.9% |
| Embodiment 11 | 45 | 1.9 | 300 | 1.55 | 81.5% |
| Embodiment 12 | 42 | 2 | 290 | 1.6 | 81.6% |
| Embodiment 13 | 41 | 2.2 | 310 | 1.9 | 86.8% |
| Embodiment 14 | 40 | 2 | 290 | 1.7 | 85% |
| Embodiment 15 | 40 | 1.9 | 250 | 1.4 | 73.6% |
| Embodiment 16 | 42 | 1.9 | 295 | 1.8 | 83.4% |
| Embodiment 17 | 43 | 2.1 | 300 | 1.6 | 76% |
| Comparative | 55 | 2.3 | 240 | 1.5 | 65.2% |
| Example 1 | | | | | |
| Comparative | 60 | 2.2 | 200 | 1.45 | 65.9% |
| Example 2 | | | | | |
| Comparative | 62 | 2.4 | 250 | 1.6 | 66.7% |
| Example 3 | | | | | |

From the data in Embodiment 1 and Comparative Examples 1 and 2, it can be seen that using a rubber powder can achieve the same performance as using an ordinary reinforcing filler, and has even better performance. After a double-85 aging test, the retention rate of tensile strength reaches more than 70%. This is conducive to the long-tem outdoor use of an adhesive, and because the costs of the rubber powder is lower, the costs of the silicone adhesive are reduced.

From Embodiment 1 and Embodiment 15, it can be seen that the addition of a dry silane is conducive to improving the compatibility of the rubber powder with the system, thereby improving the tensile strength and aging resistance. High tensile strength is conducive to the improvement of bonding properties and the prevention of bonding failure. Good moisture and heat aging resistance is conducive to prolonging the service life of the adhesive.

The above embodiments are only preferred embodiments of the present invention, and are not intended to limit the present invention. For one skilled in the art, the present invention may have various modifications and changes. Any modification, equivalent replacement, improvement, etc. made within the spirit and principle of the present invention shall be encompassed by the scope of protection of the present invention.

1-10. (canceled)

11. A silicone adhesive comprising:
a polysiloxane having at least one selected from the group of hydroxyl group and hydrolyzable group bonded with a silicon atom;
a catalyst;
a cross-linking agent; and
a filler,
wherein the filler comprises particles of rubber.

12. The silicone adhesive of claim 11, wherein the hydrolyzable group is at least one selected from the group of alkoxy group and alkoxy-substituted alkoxy group.

13. The silicone adhesive of claim 11, wherein the hydrolyzable group is at least one selected from the group of alkoxy group having from one to 10 carbon atoms and alkoxy-substituted alkoxy group having from two to 10 carbon atoms,

14. The silicone adhesive of claim 11, wherein the hydrolyzable group is at least one selected from the group of alkoxy group having from one to four carbon atoms and alkoxy-substituted alkoxy group having from two to four carbon atoms.

15. The silicone adhesive of claim 11, wherein the hydrolyzable group is at least one selected from the group of methoxy group, ethoxy group, propoxy group, isopropoxy group, butoxy group, isobutoxy group, hexyloxy group, octyloxy group, methoxymethoxy group, methoxvethoxv group, ethoxymethoxy group, and ethoxyethoxy group.

16. The silicone adhesive of claim 11, wherein the filler is at least one selected from the group of natural rubber, nitrile-butadiene rubber, cis-butadiene rubber, styrene-butadiene rubber, isoprene rubber, chloroprene rubber, and ethylene propylene rubber.

17. The silicone adhesive of claim 11, wherein the filler comprises particles of recycled rubber.

18. The silicone adhesive of claim 11, wherein the average particle size of the particles of rubber is less than or equal to 50 mesh.

19. The silicone adhesive of claim 11, wherein the average particle size of the particles of rubber is from 50 to 500 mesh.

20. The silicone adhesive of claim 11, wherein the average particle size of the particles of rubber is from 80 to 400 mesh.

21. The silicone adhesive of claim 11, wherein the filler comprises from 10% to 70% by weight the particles of rubber.

22. The silicone adhesive of claim 11, wherein the filler comprises from 20% to 60% by weight the particles of rubber.

23. The silicone adhesive of claim 11, wherein the filler further includes at least one selected from the group of calcium carbonate, talc powder, zinc borate, phosphate, titanium dioxide, silica powder, quartz powder, aluminum hydroxide, aluminum oxide, white carbon black, magnesium oxide, zinc oxide, barium carbonate, diatomite, kaolin, and montmorillonite.

24. The silicone adhesive according of claim 11, wherein the silicone adhesive further includes at least one selected from the group of silane coupling agent containing an alkyl bgroup with 12 or more carbon atoms and titanate coupling agent containing a carbon chain with 12 or more carbon atoms.

25. The silicone adhesive of claim 11, wherein based on 100 parts of the polysiloxane by mass, the silicone adhesive comprises
from 0.01 to one part by mass the catalyst,
from one to 30 parts by mass the cross-linking agent, and
from 10 to 300 parts by mass the filler.

26. The silicone adhesive of claim 11, wherein based on 100 parts of the polysiloxane by mass, the silicone adhesive comprises
from 0.1 to 0.6 parts by mass the catalyst,
from five to 20 parts by mass the cross-linking agent, and
from 100 to 200 parts by mass the filler.

27. The silicone adhesive of claim 11, wherein based on 100 parts of the polysiloxane by mass, the silicone adhesive comprises, the silicone adhesive further comprises from 0.1 to 20 parts by mass a coupling agent.

28. The silicone adhesive of claim 27, wherein the coupling agent is at least one selected. from the group of silane coupling agent and titanate coupling agent;

29. The silicone adhesive of claim 27, wherein the coupling agent is at least one selected from the group of aminosilane coupling agent, epoxysilane coupling agent, acyloxysilane coupling agent, vinylsilane coupling agent, titanate silane coupling agent, mercaptosilane coupling agent, and isocyanate silane coupling agent.

30. The silicone adhesive of claim 27, wherein the coupling agent is at least one selected from the group of γ-aminopropylttimethoxysilane, γ-aminopropyttriethoxysilane, γ-aminopropylmethyldimethoxysilane, γ-aminopropylmethyldiethoxysilane, aniline methyltriethoxysilane, γ-(methacryloxy)propyltrimethoxysilane, N-(β-aminoethyl)-γ-aminopropyltrimethoxysilane, N-(β-aminoethyl)-γ-aminopropyltriethoxysilane, N-(β-aminoethyl)-γ-aminopropylmethyidimethoxysilane, γ-mercaptopropyltrimethoxysilane, γ-mercaptopropyltriethoxysilane, γ-(2,3)-epoxypropoxy)propyltriethoxysilane, 3-[(2,3)-epoxypropoxy]propylmethyidimethoxysilane, propyltnethoxysilane isocyanate, γ-ureidopropyltrimethoxysilane, and γ-glycidoxypropyltrimethoxysilane.
